(19) United States
(12) Patent Application Publication
(10) Pub. No.: US 2013/0109858 A1
(43) Pub. Date: May 2, 2013

(54) METHOD OF SYNTHESIZING CORE-EXPANDED PERYLENE DIIMIDE DYE AND NOVEL CORE-EXPANDED PERYLENE DIIMIDE DYE

(71) Applicant: Nobukazu Negishi, Ibaraki (JP)

(72) Inventor: Nobukazu Negishi, Ibaraki (JP)

(73) Assignee: NITTO DENKO CORPORATION, Ibaraki, Osaka (JP)

(21) Appl. No.: 13/390,004

(22) PCT Filed: Jul. 16, 2010
(86) PCT No.: PCT/US10/42250

§ 371 Date: Feb. 10, 2012

(51) Int. Cl. C09B 5/62

(52) U.S. Cl. CPC C09B 5/62
USPC 546/26; 204/157.71

(57) ABSTRACT

A core-expanded perylene diimide compound having general formula A useful as a fluorescent dye is synthesized:

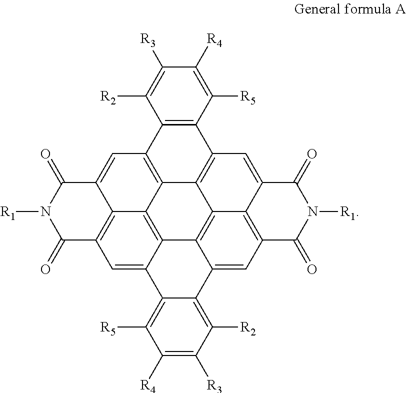

### CROSS-REFERENCE TO RELATED APPLICATIONS

This application is the U.S. National Phase under 35 U.S.C. §371 of International Application PCT/US2010/042250, filed on Jul. 16, 2010, which claims priority to U.S. Provisional Patent Application No. 61/235,483, filed Aug. 20, 2009, the disclosure of which is incorporated herein by reference in its entirety. The International Application was published under PCT Article 21(2) in English.

### BACKGROUND

1. Field of the Invention

The present invention generally relates to a method of synthesizing a core-expanded perylene diimide dye and a novel core-expanded perylene diimide dye which is useful as a fluorescent dye in various areas.

2. Description of the Related Art

In the recent years, with the need for new optical light collection systems, fluorescence-based solar collectors, fluorescence-activated displays and single-molecule spectroscopy, various approaches to realizing perylene dyes have been explored, but many technical issues still need to be overcome.

A prior art, Chemistry-European Journal 2007, 13, page 6555-6561, describes dibenzocoronene compounds synthesized from perylenes. However, its yield by the process is low and the process also requires a dibromo precursor, which limits structural variations of the target compounds produced. The reaction described in the prior art, which is known as Heck reaction, requires a complex precursor and thus, there are difficulties synthesizing various core-expanded perylene derivatives.

Hence, there is an urgent need for perylene dyes having more structural variations and a method for synthesizing them for improved yield.

### SUMMARY

Consequently, in an aspect, an object of the disclosed embodiments of the present invention is to provide a core-expanded perylene derivative on which diffractive grating can be written and read-out. By employing the perylene derivative, a new type of optical light collection system, fluorescence-based solar collectors, fluorescence-activated displays, and single-molecule spectroscopy can be provided.

Another aspect of the disclosed embodiments of the present invention provides a method to synthesize a perylene derivative using photochemical or oxidative reactions having remarkably high yield, in which many structural variations of perylene derivatives are obtainable.

In an embodiment, provided is a core-expanded perylene diimide compound having general formula A:

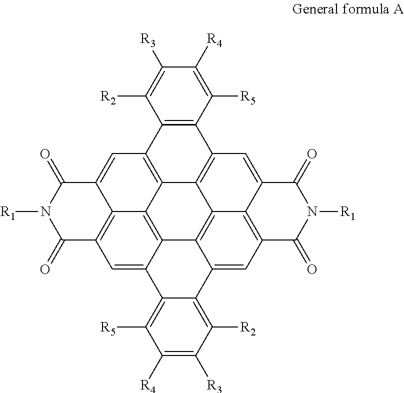

wherein R₁ is selected form the group consisting of hydrogen, alkyl, cycloalkyl, aryl, and aralkyl; R₂ and R₃ are each independently selected from the group consisting of hydrogen, alkyl, aryl, hetaryl, halogen, cyano, nitro, —OR₆, —COR₆, —COOR₆, —OCOR₆, —CONR₆R₇, —OCONR₆R₇, —NR₆R₇, —NR₆COR₇, —NR₆COOR₇, —NR₆SO₂R₇, —SO₂R₆, —SO₂NR₆R₇, and —N═N—R₆, or R₂ and R₃ together form a substituted or unsubstituted condensed benzene ring; R₄ and R₅ are each independently selected from the group consisting of hydrogen, alkyl, aryl, hetaryl, halogen, cyano, nitro, —OR₆, —COR₆, —COOR₆, —OCOR₆, —CONR₆R₇, —OCONR₆R₇, —NR₆R₇, —NR₆COR₇, —NR₆COOR₇, —NR₆SO₂R₇, —SO₂R₆, —SO₂NR₆R₇, and —N═N—R₆; and R₆ and R₇ are each independently selected from the group consisting of hydrogen, C₁-C₄alkyl, phenyl, and 4-tolyl, with the proviso that when all of R₂ to R₅ are hydrogen, R₁ is not alkyl nor aryl.

In an embodiment, R₂ and R₃ together do not form a substituted or unsubstituted condensed benzene ring. In an embodiment, at last one of R₂ to R₅ may not be hydrogen. In an embodiment, each R₁ may be aryl.

In an alternative embodiment, R₂ and R₃ together form a substituted or unsubstituted condensed benzene ring. In an embodiment, the condensed benzene ring may be unsubstituted, and R₄ and R₅ are hydrogen. In an embodiment, the condensed benzene ring may have at least one substituent selected from the group consisting of alkyl, aryl, hetaryl, halogen, cyano, nitro, —OR₆, —COR₆, —COOR₆, —OCOR₆, —CONR₆R₇, —OCONR₆R₇, —NR₆R₇, —NR₆COR₇, —NR₆COOR₇, —NR₆SO₂R₇, —SO₂R₆, —SO₂NR₆R₇, and —N═—R₆.

In an embodiment, provided is a method for synthesizing a core-expanded perylene diimide compound having general formula A:

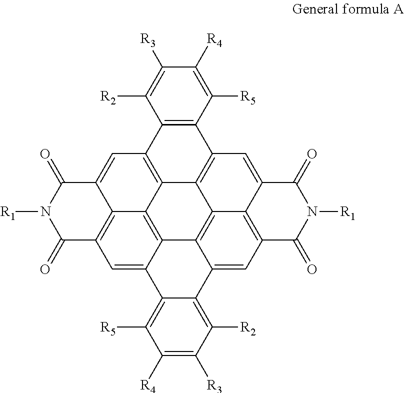

wherein R₁ is selected form the group consisting of hydrogen, alkyl, cycloalkyl, aryl, and aralkyl; R₂ and R₃ are each independently selected from the group consisting of hydrogen, alkyl, aryl, hetaryl, halogen, cyano, nitro, —OR₆, —COR₆, —COOR₆, —OCOR₆, —CONR₆R₇, —OCONR₆R₇, —NR₆R₇, —NR₆COR₇, —NR₆COOR7, —NR₆SO₂R₇, —SO₂R₆, —SO₂NR₆R₇, and —N═N—R₆, or R₂ and R₃ together form a substituted or unsubstituted condensed benzene ring; R₄ and R₅ are each independently selected from the group consisting of hydrogen, alkyl, aryl, hetaryl, halogen, cyano, nitro, —OR₆, —COR₆, —COOR₆, —OCOR₆, —CONR₆R₇, —OCONR₆R₇, —NR₆R₇, —NR₆COR₇, —NR₆COOR₇, —NR₆SO₂R₇, —SO₂R₆, —SO₂NR₆R₇, and —N═N—R₆; and R₆ and R₇ are each independently selected from the group consisting of hydrogen, C₁-C₄alkyl, phenyl, and 4-tolyl, said method comprising:
providing as a precursor a 1,7-diarylperylene-3,4:9,10-bis(dicarboximide) having general formula B,

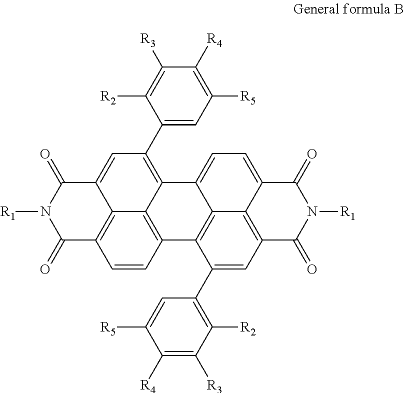

wherein R₁ to R₅ are the same as those defined in general formula A, and the phenyl having R₂ to R₅ or a naphthyl wherein R₂ and R₃ together form a benzene ring fused to the phenyl is photoreactive;
irradiating the precursor with light having an excitation wavelength of about 300 nm to about 450 nm until the core-expanded perylene diimide compound is synthesized.

In an embodiment, each phenyl in general formula B may be an unsubstituted phenyl or substituted phenyl having R₂ to R₅ wherein at least one of R₂ to R₅ is hetaryl, halogen, cyano, nitro, —COR₆, —COOR₆, or —SO₂R₆. In an embodiment, each phenyl in general formula B forms a substituted or unsubstituted naphthyl wherein R₂ and R₃ together form a benzene ring fused to the phenyl.

In alternative embodiment, provided is a method for synthesizing a core-expanded perylene diimide compound having general formula A:

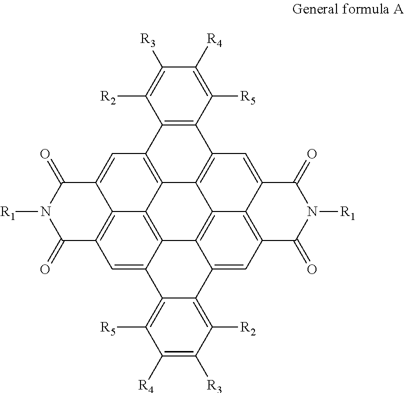

wherein R₁ is selected form the group consisting of hydrogen, alkyl, cycloalkyl, aryl, and aralkyl; R₂ and R₃ are each independently selected from the group consisting of hydrogen, alkyl, aryl, hetaryl, halogen, cyano, nitro, —OR₆, —COR₆, —COOR₆, —OCOR₆, —CONR₆R₇, —OCONR₆R₇, —NR₆R₇, —NR₆COR₇, —NR₆COOR₇, —NR₆SO₂R₇, —SO₂R₆, —SO₂NR₆R₇, and —N═N—R₆, or R₂ and R₃ together form a substituted or unsubstituted condensed benzene ring; R₄ and R₅ are each independently selected from the group consisting of hydrogen, alkyl, aryl, hetaryl, halogen, cyano, nitro, —OR₆, —COR₆, —COOR₆, —OCOR₆, —CONR₆R₇, —OCONR₆R₇, —NR₆R₇, —NR₆COR₇, —NR₆COOR₇, —NR₆SO₂R₇, —SO₂R₆, —SO₂NR₆R₇, and —N═N—R₆; and R₆ and R₇ are each independently selected from the group consisting of hydrogen, C₁-C₄alkyl, phenyl, and 4-tolyl, said method comprising:
providing as a precursor a 1,7-diarylperylene-3,4:9,10-bis(dicarboximide) having general formula B,

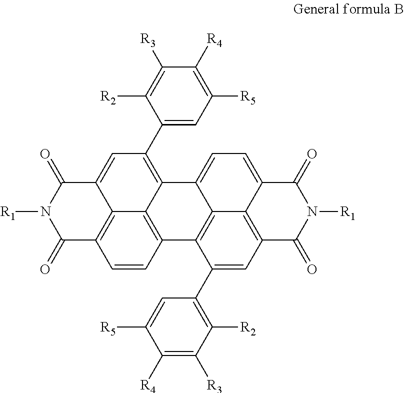

wherein R₁ to R₅ are the same as those defined in general formula A, and the phenyl having R₂ to R₅ or a naphthyl wherein R₂ and R₃ together form a benzene ring fused to the phenyl is electronically oxidizable; and
reacting the precursor with a Fe(III) reagent until the core-expanded perylene diimide compound is synthesized.

In an embodiment, each phenyl in general formula B may be a substituted phenyl having R₂ to R₅ wherein at least one of R₂ to R₅ is —OR₆ or —NR₆R₇. In an embodiment, each phenyl in general formula B forms a substituted or unsubstituted naphthyl wherein R₂ and R₃ together form a benzene ring fused to the phenyl.

In any of the foregoing embodiments, the yield can be as high as nearly or substantially 100%.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### DETAILED DESCRIPTION

The embodiments will be explained with respect to preferred embodiments which are not intended to limit the present invention. In the present disclosure, the listed substituent groups include both further substituted and unsubstituted groups unless specified otherwise. Further, in the present disclosure where conditions and/or structures are not specified, the skilled artisan in the art can readily provide such conditions and/or structures, in view of the present disclosure, as a matter of routine experimentation.

In view of the invention background described above, the conventional synthesis methods for a core-expanded perylene diimide have the shortcomings of limited structural variations and poor yield. Therefore, it is an aspect of the present invention to provide further structural variations of core-expanded perylene diimide and improved yield of the product.

In a first embodiment, provides is a core-expanded perylene diimide compound having general formula 1:

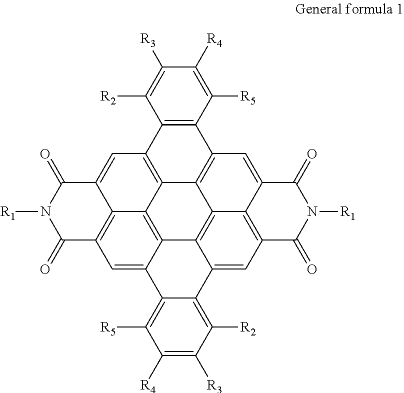

where R₁ is independently selected form the group consisting of hydrogen, alkyl, cycloalkyl, substituted alkyl, aryl, substituted aryl, aralkyl and substituted aralkyl group; R₂ to R₅ are each independently selected from the group consisting of hydrogen, alkyl, aryl, hetaryl, halogen, cyano, nitro, —OR₆, —COR₆, —COOR₆, —OCOR₆, —CONR₆R₇, —OCONR₆R₇, —NR₆R₇, —NR₆COR₇, —NR₆COOR₇, —NR₆SO₂R₇, —SO₂NR₆R₇ and —N═N—R₆; and R₆ and R₇ are each independently selected from the group consisting of hydrogen, C₁-C₄alkyl, phenyl and 4-tolyl. It should be noted that a dibenzocoronenebis(discarboximide) having alkyl or aryl at R₁ and hydrogen atoms at R₂-R₅ may be excluded from the first embodiment. A preferred alkyl may be one having a one to twelve carbon atoms. A preferred aryls may be phenyl or naphthyl. A preferred hetaryl may be pyridine, bipyridine, imidazole, or benzothiadiazole. A Preferred halogen may be fluorine or chlorine.

In a second embodiment, the core-expanded perylene diimide having general formula 1 may be synthesized by irradiating a 1,7-diarylperylene-3,4:9,10-bis(dicarboximide) having general formula 3 with light having an excitation wavelength of about 300 nm to about 450 nm, preferably about 365 nm, wherein R₁ to R₅ are the same as those defined in general formula 1.

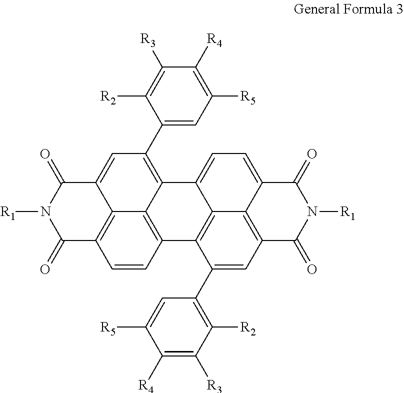

The reaction temperature may be raised due to heat generated by UV irradiation. For example, the temperature may be approximately 40° C. in the case where dichloromethane is used as a solvent. Since this reaction follows the Woodward-Hoffman principle, the temperature may, theoretically not affect the reaction, although high temperature is not preferred since an undesired thermal reaction might occur. The environment for the reaction may include the atmosphere or any suitable oxygen-containing atmosphere, since the reaction requires oxygen. The pressure may be atmospheric pressure. Light intensity for irradiation may be 20 mW/cm² or more, where the reaction time may be proportional to the light intensity and the irradiated area in an embodiment. The reaction may be complete in three days to one week in an embodiment.

This synthesis method is preferred where the phenyl of 1,7-diarylperylene-3,4:9,10-bis(dicarboximide) is photoreactive or serves as an electron acceptor. Examples of the electron acceptor include, but are not limited to, aryl, hetaryl, halogen, cyano, nitro, —COR₆, —COOR₆, —SO₂R₆, and —SO₂NR₆R₇. The reaction time tends to be shorter when the phenyl is a stronger electron acceptor. For the purpose of preventing from producing isomers, it is preferred that a single substituent is attached to the 4 position, two substituents are attached to the 3 and 5 positions, or any other substituents are attached to positions having the symmetrical relationship with respect to the phenyl ring in general formula 3. Having different substituents on the phenyl ring will result in various isomers, which leads to difficulties controlling characteristics of the final product. In an embodiment, a single substituent may be attached to the 2 position which is better than the 3 or 5 position because the substituent at the 2 position can retain reaction selectivity and symmetrical reactivity.

In a third embodiment, the core-expanded perylene diimide having general formula 1 may be synthesized by reacting a 1,7-diarylperylene-3,4:9,10-bis(dicarboximide) having general formula 3 with a Fe(III) reagent wherein the Fe(III) reagent may be one or more selected from the group consisting of FeCl₃, FeBr₃, Fe(ClO₄)₃ and Fe(acetylacetonate)₃. This synthesis method is preferred where the phenyl of 1,7-diarylperylene-3,4:9,10-bis(dicarboximide) is electronically oxidizable or serves as an electron donor. Examples of the electron donor include, but are not limited to, alkyl, —OR₆, and —NR₆R₇, for example. The reaction is favorable when the phenyl groups having R₂ to R₅ are oxidizable due to the electron donor substituent. For the purpose of preventing from producing isomers, it is preferred that a single substituent is attached to the 4 position, two substituents are attached to the 3 and 5 positions, or any other substituents are attached to positions having the symmetrical relationship with respect to the phenyl ring in general formula 3. Having different substituents on the phenyl ring will result in various isomers, which leads to difficulties controlling characteristics of the final product. In an embodiment, a single substituent may be attached to the 2 position which is better than the 3 or 5 position because the substituent at the 2 position can retain reaction selectivity and symmetrical reactivity.

In the reaction using the Fe(III) reagent, the compound may be dissolved in a solvent such as dichloromethane and chloroform (depending on the solubility of the compound) in a concentration of 0.01 to 0.1 mol/L in an embodiment. Further, for dissolving the Fe(III) reagent, a slight amount of nitromethane may be used in an embodiment. The temperature may be about 15° C. to about 25° C. in an embodiment. The reaction duration may be 1 to 3 hours in an embodiment.

The skilled artisan will appreciate which reaction (i.e., reaction using UV light or reaction using Fe(III)) is suitable for the particular precursor based on the reactivity of the phenyl ring in view of the above.

In a fourth embodiment, the core-expanded perylene diimide having general formula 1 may be used as a fluorescent dye in a chemiluminescence system, an optical light collection system, a fluorescence-based solar collector, a fluorescence-activated display or a single molecule spectroscopy. The skilled artisan will appreciate the above use in view of the present disclosure, as a matter of routine experimentation. In a fluorescence-based solar collector, the highly stable perylene material can be used as a wavelength conversion dye which efficiently converts unusable wavelengths to the wavelengths that a solar cell can convert into electricity. In a fluorescence-activated display, the core-expanded perylene diimide can be used as a dye which converts blue or ultraviolet rays from an organic light-emitting diode (OLED) into RGB colors for full color display. In a single molecule spectroscopy, the core-expanded perylene diimide can be used as a dye for detecting cancer, for example. Protein or DNA is tagged with the perylene dye where the dye is required to be highly stable and has high quantum efficiencies.

In a fifth embodiment, provided is a core-expanded perylene diimide compound having general formula 2:

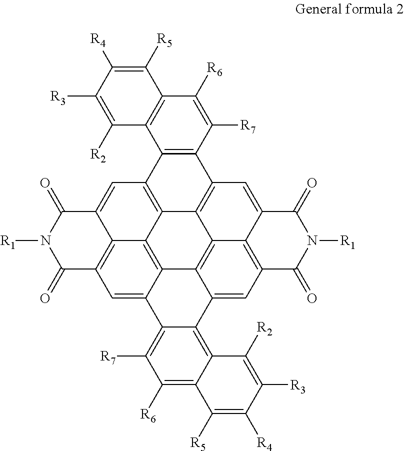

where R₁ is each independently selected form the group consisting of hydrogen, alkyl, cycloalkyl, substituted alkyl, aryl, substituted aryl, aralkyl and substituted aralkyl group; R₂ to R₇ are selected from the group consisting of hydrogen, alkyl, aryl, hetaryl, halogen, cyano, nitro, —OR₈, —COR₆, —COOR₈, —OCOR₈, —CONR₈R₉, —OCONR₈R₉, —NR₈R₉, —NR₈COR₉, —NR₈COOR₉, —NR₈SO₂R₉, —SO₂R₈, —SO₂NR₈R₉ and —N═N—R₈; and R₈ and R₉ are each independently selected from the group consisting of hydrogen, C₁-C₄alkyl, phenyl and 4-tolyl. A preferred alkyl may be one having one to twelve carbon atoms. A preferred aryl may be phenyl or naphthyl. A preferred hetaryl may be pyridine, bipyridine, imidazole, or benzothiadiazole. A preferred halogen may be fluorine or chlorine.

In a sixth embodiment, the core-expanded perylene diimide having general formula 2 may be synthesized by irradiating a 1,7-diarylperylene-3,4:9,10-bis(dicarboximide) having general formula 4 with light having an excitation wavelength of about 300 nm to about 450 nm, preferably about 365 nm.

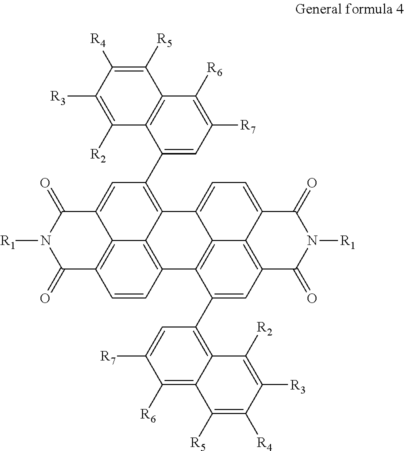

wherein R₁ to R₇ are the same as those defined in general formula 2.

The above photochemical reaction can be performed in a similar manner to that described for the compounds shown in general formula 1.

This synthesis method is preferred where the naphthyl ring of 1,7-diarylperylene-3,4:9,10-bis(dicarboximide) is photoreactive or serves as an electron acceptor. Examples of the electron acceptor include, but are not limited to, aryl, hetaryl, halogen, cyano, nitro, —COR₈, —COOR₈, —SO₂R₈, and —SO₂NR₈R₉.

In a seventh embodiment, the core-expanded perylene diimide having general formula 2 is synthesized by reacting a 1,7-diarylperylene-3,4:9,10-bis(dicarboximide) having general formula 4 with a Fe(III) reagent.

The Fe(III) reagent may be one or more selected from the group consisting of FeCl₃, FeBr₃, Fe(ClO₄)₃ and Fe(acetylacetonate)₃. This synthesis method is preferred where the naphthyl ring of 1,7-diarylperylene-3,4:9,10-bis(dicarboximide) is electronically oxidizable or serves as an electron donor. Examples of the electron donor include, but are not limited to, alkyl, —OR₈, and —NR₈R₉. The reaction is favorable when the naphthyl ring having R₂ to R₇ is oxidizable due to the electron donor substituent.

The above oxidizing reaction can be performed in a similar manner to that described for the compounds shown in general formula 1.

In an eighth embodiment, the core-expanded perylene diimide having general formula 2 may be used as a fluorescent dye in a chemiluminescence system, an optical light collection system, a fluorescence-based solar collector, a fluorescence-activated display or a single molecule spectroscopy in a similar manner to that in the core-expanded perylene diimide having general formula 1.

In the present disclosure where conditions and/or structures are not specified, the skilled artisan in the art can readily provide such conditions and/or structures, in view of the present disclosure, as a matter of routine experimentation. In this connection, the disclosure of U.S. provisional patent applications No. 61/034,906 and No. 61/155,978 owned by the same assignee as in this application can be used in an embodiment, the disclosure of which is incorporated herein by reference in its entirety.

The compounds shown in general formulas 3 and 4 can be obtained by any suitable method including, but not limited to, any conventional methods including Suzuki conditions (Chem. Eur. J., 2007, 13, 6555-6561) and the Stille reaction.

The present invention will be explained in detail with reference to specific examples which are not intended to limit the present invention. The numerical numbers applied in specific examples may be modified by the skilled artisan. In the present disclosure, the endpoints of the ranges in an embodiment may be included or excluded in another embodiment. The skilled artisan will appreciate that although the following examples used compounds with specific substituents, because exclusively the phenyl or naphthyl serves as an electron donor or an electron acceptor, and an expanded aryl, other substituents having similar characteristics will go through similar synthesis steps and can be obtained without undue experimentation. In the examples, the purity of all the compounds obtained from each step was 99% or higher.

### EXAMPLE 1

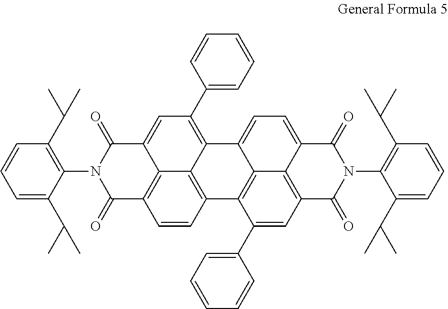 [SMILES: CC(C)c1cccc(C(C)C)c1N1C(=O)c2ccc3c4c(-c5ccccc5)cc5c6c(ccc(c7c(-c8ccccc8)cc(c2c37)C1=O)c64)C(=O)N(c1c(C(C)C)cccc1C(C)C)C5=O]

1) First, to synthesize N,N′-bis(diisopropylphenyl)-1,7-diphenylperylene-3,4:9,10-bis(dicarboximide) as shown in general formula 5, tetrakis(triphenylphosphine)palladium(0) (34 mg, 0.029 mmol) was added to a solution of N,N′-bis(diisopropylphenyl)-1,7-dibromoperylene-3,4:9,10-bis(dicarboximide) (330 mg, 0.38 mmol), phenylboronic acid (112 mg, 0.90 mmol) in toluene (12 mL), an aqueous solution of 2M K₂CO₃ (4 mL) and ethanol (2 mL) under argon atmosphere. The resulting mixture was stirred for 15 h at 70° C. After palladium catalyst was removed by filtration, the solvent was removed under reduced pressure. The residue was purified by column chlomatography on silica gel (dichloromethane) to obtain N,N′-bis(diisopropylphenyl)-1,7-diphenylperylene-3,4:9,10-bis(dicarboximide) (328 mg, 100% yield).

N,N′-bis(diisopropylphenyl)-1,7-diphenylperylene-3,4:9,10-bis(dicarboximide) obtained from the process was dark-red solid. Thin layer chromatography (TLC) with dichloromethane showed retention factor value (RD of 0.70. 1H nuclear magnetic resonance (NMR) analysis with deuterated chloroform (CDCl₃) showed δ: 1.14-1.62 (m, 24H), 2.74 (quint, J=6.8 Hz, 4H), 7.33 (d, J=7.7 Hz, 4H), 7.48 (t, J=7.7 Hz, 2H), 7.50-7.56 (m, 6H), 7.63 (d, J=6.6 Hz, 4H), 7.92 (d, J=8.0 Hz, 2H), 8.21 (d, J=8.0 Hz, 2H), 8.72 (s, 2H).

2) Secondly, N,N′-bis(diisopropylphenyl)-1,7-diphenylperylene-3,4:9,10-bis(dicarboximide) (100 mg, 0.116 mmol) in dichloromethane (500 mL) placed in a flask was directly irradiated with a UV lamp (20 mW/cm2 at 2 inch, 365 nm, approximately 40° C., in atmospheric environment, the irradiated area was approximately 200 cm²) for 4 days. The reaction mixture was concentrated under reduced pressure to afford the crude product and purified by column chromatography on silica gel (dichloromethane) to obtain the ring-closed compound (100 mg, 100% yield) shown in general formula 6.

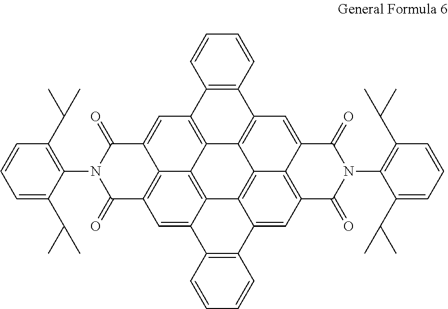

The product obtained from the process was orange solid. TLC with dichloromethane showed Rf of 0.70. 1H NMR analysis with CDCl₃ showed δ: 1.28 (d, J=6.8 Hz, 24H), 3.18 (quint, J=6.8 Hz, 4H), 7.48 (d, J=7.7 Hz, 4H), 7.60 (t, J=7.7 Hz, 2H), 8.21-8.24 (m, 4H), 9.60-9.64 (m, 4H), 10.75 (s, 4H).

### EXAMPLE 2

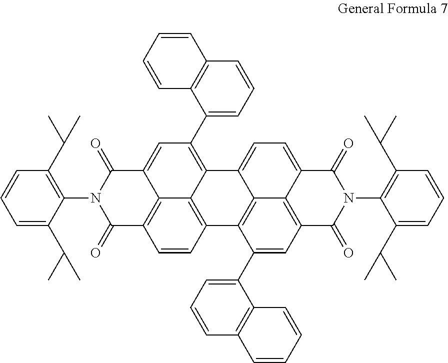 [SMILES: CC(C)c1cccc(C(C)C)c1N1C(=O)c2ccc3c4c(-c5cccc6ccccc56)cc5c6c(ccc(c7c(-c8cccc9ccccc89)cc(c2c37)C1=O)c64)C(=O)N(c1c(C(C)C)cccc1C(C)C)C5=O]

1) First, to synthesize N,N′-bis(diisopropylphenyl)-1,7-bis(1-naphthyl)perylene-3,4:9,10-bis(dicarboximide) as shown in general formula 7, tetrakis(triphenylphosphine)palladium(0) (13 mg, 0.011 mmol) was added to a solution of N,N′-bis(diisopropylphenyl)-1,7-dibromoperylene-3,4:9,10-bis(dicarboximide) (100 mg, 0.115 mmol), 1-naphthylboronic acid (60 mg, 0.35 mmol) in toluene (6 mL), an aqueous solution of 2M K2CO3 (2 mL) and ethanol (1 mL) under argon atmosphere. The resulting mixture was stirred for 15 h at 70° C. After palladium catalyst was removed by filtration, the solvent was removed under reduced pressure. The residue was purified by column chlomatography on silica gel (dichloromethane) to obtain N,N′-bis(diisopropylphenyl)-1,7-bis(1-naphthyl)perylene-3,4:9,10-bis(dicarboximide) (100 mg, 91% yield, two conformational isomers, 1:1 ratio).

N,N′-bis(diisopropylphenyl)-1,7-bis(1-naphthyl)perylene-3,4:9,10-bis(dicarboximide) obtained from the process was Dark-red solid. TLC with dichloromethane showed Rf of 0.70. 1H NMR analysis with CDCl₃ showed δ: 1.14-1.62 (m, 24H), 2.68-2.74 (m, 4H), 7.28 (d, J=7.7 Hz, 4H), 7.44 (t, J=7.7 Hz, 2H), 7.48-7.72 (m, 8H), 7.80 (d, J=8.0 Hz, 1H), 7.83 (d, J=8.0 Hz, 1H), 7.90-7.92 (m, 2H), 8.00-8.05 (m, 6H), 8.69, 8.70 (two conformational isomers (1:1), s, 2H).

2) Secondly, N,N′-bis(diisopropylphenyl)-1,7-bis(1-naphthyl)perylene-3,4:9,10-bis(dicarboximide) (100 mg, 0.104 mmol) in dichloromethane (500 mL) placed in a flask was directly irradiated with a UV lamp (20 mW/cm2 at 2 inch, 365 nm, approximately 40° C., in atmospheric environment, the irradiated area was approximately 200 cm²) for 4 days. The reaction mixture was concentrated under reduced pressure to afford the crude product and purified by column chromatography on silica gel (dichloromethane) to obtain the ring-closed compound shown in general formula 8 (100 mg, 100% yield).

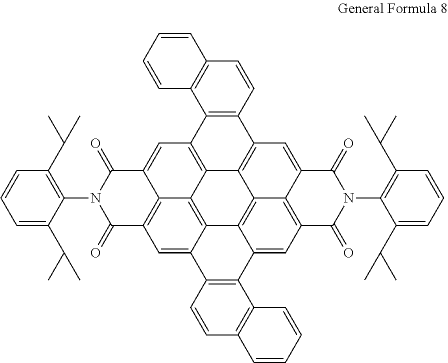

The product obtained from the process was red solid. TLC with dichloromethane showed Rf of 0.70. 1H NMR analysis with CDCl3 showed δ 1.28-1.35 (m, 24H), 3.06 (quint, J=6.8 Hz, 4H), 7.48 (d, J=7.7 Hz, 4H), 7.61 (t, J=7.7 Hz, 2H), 7.91 (t, J=7.3 Hz, 2H), 7.98 (t, J=7.3 Hz, 2H), 8.35 (d, J=7.3 Hz, 2H), 8.54 (d, J=7.3 Hz, 2H), 9.45 (d, J=7.3 Hz, 2H), 9.54 (d, J=7.3 Hz, 2H), 10.87 (s, 2H), 11.16 (s, 2H).

3) Thirdly, an alternative to the synthesis method described above (2) of Example 2, Iron(III) chloride (360 mg, 2.24 mmol) in nitromethane (3 mL) was added dropwise to a solution of N,N′-bis(diisopropylphenyl)-1,7-bis(1-naphthyl)perylene-3,4:9,10-bis(dicarboximide) (100 mg, 0.104 mmol) in degassed dichloromethane (60 mL) under argon atmosphere. After being stirred for 3 h at room temperature, the solution was quenched by adding hydrazine (1 mL), and the precipitate was filtered. The collected solution was washed with water for three times and dried by MgSO₄. The solution was concentrated under reduced pressure to afford the crude product and purified by column chromatography on silica gel (dichloromethane) to obtain the ring-closed compound shown in general formula 8 (100 mg, 100% yield).

The product obtained from the process was red solid. TLC with dichloromethane showed Rf of 0.70. 1H NMR analysis with CDCl₃ showed δ: 1.28-1.35 (m, 24H), 3.06 (quint, J=6.8 Hz, 4H), 7.48 (d, J=7.7 Hz, 4H), 7.61 (t, J=7.7 Hz, 2H), 7.91 (t, J=7.3 Hz, 2H), 7.98 (t, J=7.3 Hz, 2H), 8.35 (d, J=7.3 Hz, 2H), 8.54 (d, J=7.3 Hz, 2H), 9.45 (d, J=7.3 Hz, 2H), 9.54 (d, J=7.3 Hz, 2H), 10.87 (s, 2H), 11.16 (s, 2H).

### EXAMPLE 3

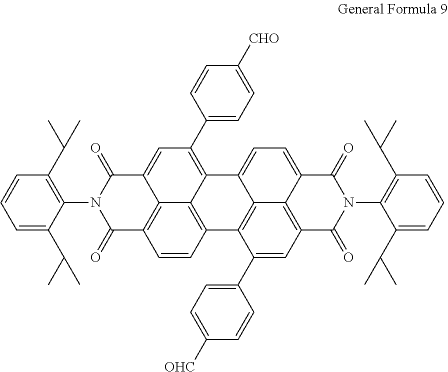 [SMILES: CC(C)c1cccc(C(C)C)c1N1C(=O)c2ccc3c4c(-c5ccc(C=O)cc5)cc5c6c(ccc(c7c(-c8ccc(C=O)cc8)cc(c2c37)C1=O)c64)C(=O)N(c1c(C(C)C)cccc1C(C)C)C5=O]

1) First, to synthesize N,N′-bis(diisopropylphenyl)-1,7-bis(4-formylphenyl)perylene-3,4:9,10-bis(dicarboximide) as shown in general formula 9, tetrakis(triphenylphosphine)palladium(0) (27 mg, 0.023 mmol) was added to a solution of N,N′-bis(diisopropylphenyl)-1,7-dibromoperylene-3,4:9,10-bis(dicarboximide) (200 mg, 0.23 mmol), 4-formylphenylboronic acid (103 mg, 0.69 mmol) in toluene (6 mL), an aqueous solution of 2M K₂CO₃ (2 mL) and, ethanol (1 mL) under argon atmosphere. The resulting mixture was stirred for 15 h at 70° C. After palladium catalyst was removed by filtration, the solvent was removed under reduced pressure. The residue was purified by column chlomatography on silica gel (dichloromethane) to obtain N,N′-bis(diisopropylphenyl)-1,7-bis(4-formylphenyl)perylene-3,4:9,10-bis(dicarboximide) (208 mg, 99% yield).

N,N′-bis(diisopropylphenyl)-1,7-bis(4-formylphenyl)perylene-3,4:9,10-bis(dicarboximide) obtained from the process was dark-red solid. TLC with dichloromethane showed Rf of 0.20, 1H NMR analysis with CDCl₃ δ: 1.14-1.62 (m, 24H), 2.74 (quint, J=6.8 Hz, 4H), 7.34 (d, J=7.7 Hz, 4H), 7.49 (t, J=7.7 Hz, 2H), 7.85 (d, J=8.0 Hz, 4H), 7.87 (d, J=8.0 Hz, 2H), 8.08 (d, J=8.0 Hz, 4H), 8.24 (d, J=8.0 Hz, 2H), 8.73 (s, 2H), 10.15 (s, 2H).

2) Secondly, N,N′-bis(diisopropylphenyl)-1,7-bis(4-formylphenyl)perylene-3,4:9,10-bis(dicarboximide) (100 mg, 0.109 mmol) in dichloromethane (500 mL) placed in a flask was directly irradiated with a UV lamp (20 mW/cm2 at 2 inch, 365 nm, approximately 40° C., in atmospheric environment, the irradiated area was approximately 200 cm²) for 3 days. The reaction mixture was concentrated under reduced pressure to afford the crude product and purified by column chromatography on silica gel (dichloromethane) to obtain the ring-closed compound shown in general formula 10 (100 mg, 100% yield).

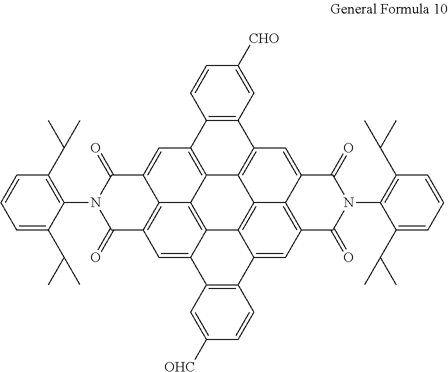

The product obtained from the process was orange solid. TLC with dichloromethane showed Rf of 0.20. 1H NMR analysis with CDCl3 showed δ: 1.14-1.62 (m, 24H), 3.00 (quint, J=6.8 Hz, 4H), 7.49 (d, J=7.7 Hz, 4H), 7.63 (t, J=7.7 Hz, 2H), 8.73 (d, J=8.4 Hz, 21-1), 9.78 (d, J=8.4 Hz, 2H), 10.11 (s, 2H), 10.62 (s, 2H), 10.80 (s, 2H), 10.86 (s, 2H).

### EXAMPLE 4

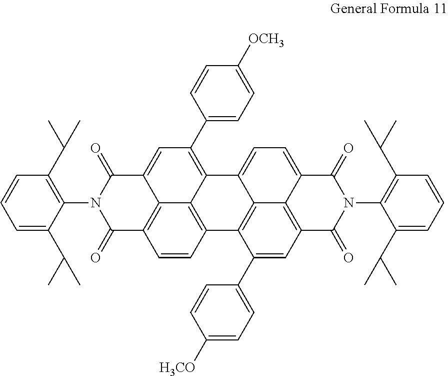 [SMILES: COc1ccc(-c2cc3c4c(ccc5c6c(-c7ccc(OC)cc7)cc7c8c(ccc(c2c45)c86)C(=O)N(c2c(C(C)C)cccc2C(C)C)C7=O)C(=O)N(c2c(C(C)C)cccc2C(C)C)C3=O)cc1]

1) First, to synthesize N,N′-bis(diisopropylphenyl)-1,7-bis(4-methoxyphenyl)perylene-3,4:9,10-bis(dicarboximide) as shown in general formula 11, tetrakis(triphenylphosphine)palladium(0) (27 mg, 0.023 mmol) was added to a solution of N,N′-bis(diisopropylphenyl)-1,7-dibromoperylene-3,4:9,10-bis(dicarboximide) (200 mg, 0.23 mmol), 4-methoxyphenylboronic acid (150 mg, 0.99 mmol) in toluene (6 mL), an aqueous solution of 2M K2CO3 (2 mL) and ethanol (1 mL) under argon atmosphere. The resulting mixture was stirred for 15 h at 70° C. After palladium catalyst was removed by filtration, the solvent was removed under reduced pressure. The residue was purified by column chromatography on silica gel (dichloromethane) to obtain N,N′-bis(diisopropylphenyl)-1,7-bis(4-methoxyphenyl)perylene-3,4:9,10-bis(dicarboximide) (210 mg, 99% yield).

N,N′-bis(diisopropylphenyl)-1,7-bis(4-methoxyphenyl)perylene-3,4:9,10-bis(dicarboximide) obtained from the process was dark-purple solid. TLC with dichloromethane showed Rf of 0.50. 1H NMR analysis with CDCl₃ showed δ: 1.14-1.18 (m, 24H), 2.75 (quint, J=6.8 Hz, 4H), 3.92 (s, 6H), 7.05 (d, J=8.8 Hz, 4H), 7.33 (d, J=7.7 Hz, 4H), 7.48 (t, J=7.7 Hz, 2H), 7.55 (d, J=8.8 Hz, 4H), 8.00 (d, J=8.0 Hz, 2H), 8.23 (d, J=8.0 Hz, 2H), 8.70 (s, 2H).

2) Secondly, Iron(III) chloride (910 mg, 5.6 mmol) in nitromethane (3 mL) was added dropwise to a solution of N,N′-bis(diisopropylphenyl)-1,7-bis(4-methoxyphenyl)perylene-3,4:9,10-bis(dicarboximide) (130 mg, 0.14 mmol) in degassed dichloromethane (30 mL) under argon atmosphere. After being stirred for 1 h at room temperature, the solution was quenched by adding water (60 mL). The collected solution was washed with water for three times and dried by MgSO₄. The solution was concentrated under reduced pressure to afford the crude product and purified by column chromatography on silica gel (dichloromethane) to obtain the ring-closed compound shown in general formula 12 (125 mg, 96% yield).

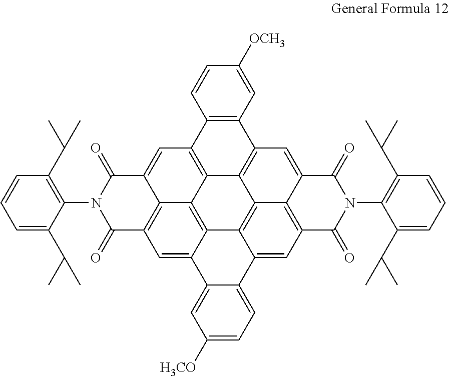

The product obtained from the process was orange-red solid. TLC with dichloromethane showed Rf of 0.50. 1H NMR analysis with CDCl3 showed δ: 1.27-1.30 (m, 24H), 3.02 (quint, J=6.8 Hz, 4H), 4.29 (s, 6H), 7.47 (d, J=7.7 Hz, 4H), 7.60 (t, J=7.7 Hz, 2H), 7.85 (dd, J=9.2, 2.6 Hz, 2H), 8.89 (d, J=2.6 Hz, 2H), 9.52 (d, J=9.2 Hz, 2H), 10.61 (s, 2H), 10.65 (s, 2H).

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. A core-expanded perylene diimide compound having general formula A: 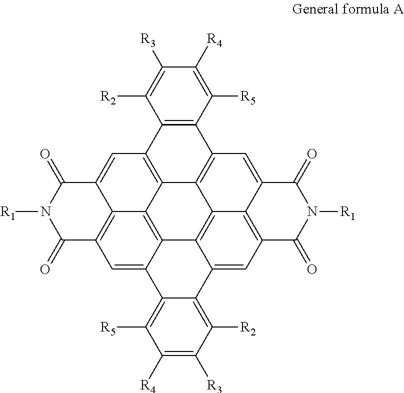
wherein R, is selected form the group consisting of hydrogen, alkyl, cycloalkyl, aryl, and aralkyl; R₂ and R₃ are each independently selected from the group consisting of hydrogen, alkyl, aryl, hetaryl, halogen, cyano, nitro, —OR₆, —COR₆, —COOR₆, —OCOR₆, —CONR₆R₇, —OCONR₆R₇, —NR₆R₇, —NR₆COR₇, —NR₆COOR₇, —NR₆SO₂R₇, —SO₂R₆, —SO₂NR₆R₇, and —N═N—R₆, or R₂ and R₃ together form a substituted or unsubstituted condensed benzene ring; R₄ and R₅ are each independently selected from the group consisting of hydrogen, alkyl, aryl, hetaryl, halogen, cyano, nitro, —OR₆, —COR₆, —COOR₆, —OCOR₆, —CONR₆R₇, —OCONR₆R₇, —NR₆R₇, —NR₆COR₇, —NR₆COOR₇, —NR₆SO₂R₇, —SO₂R₆, —SO₂NR₆R₇, and —N═N—R₆; and R₆ and R₇ are each independently selected from the group consisting of hydrogen, C₁-C₄alkyl, phenyl, and 4-tolyl, with the proviso that when all of R₂ to R₅ are hydrogen, R₁ is not alkyl nor aryl.

2. The core-expanded perylene diimide compound according to claim 1, wherein R₂ and R₃ together do not form a substituted or unsubstituted condensed benzene ring.

3. The core-expanded perylene diimide compound according to claim 2, wherein at last one of R₂ to R₅ is not hydrogen.

4. The core-expanded perylene diimide compound according to claim 2, wherein each R₁ is aryl.

5. The core-expanded perylene diimide compound according to claim 1, wherein R₂ and R₃ together form a substituted or unsubstituted condensed benzene ring.

6. The core-expanded perylene diimide compound according to claim 5, wherein the condensed benzene ring is unsubstituted, and R₄ and R₅ are hydrogen.

7. The core-expanded perylene diimide compound according to claim 5, wherein the condensed benzene ring has at least one substituent selected from the group consisting of alkyl, aryl, hetaryl, halogen, cyano, nitro, —OR₆, —COR₆, —COOR₆, —OCOR₆, —CONR₆R₇, —OCONR₆R₇, —NR₆R₇, —NR₆COR₇, —NR₆COOR₇, —NR₆SO₂R₇, —SO₂R₆, —SO₂NR₆R₇, and —N═N—R₆.

8. A method for synthesizing a core-expanded perylene diimide compound having general formula A: 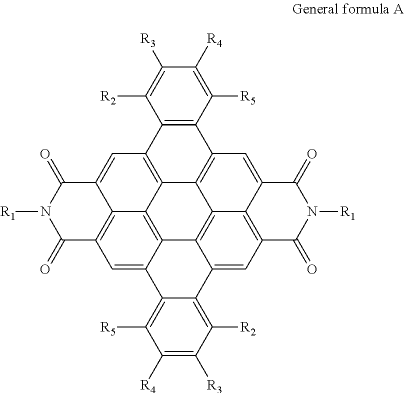
wherein R₁ is selected form the group consisting of hydrogen, alkyl, cycloalkyl, aryl, and aralkyl; R₂ and R₃ are each independently selected from the group consisting of hydrogen, alkyl, aryl, hetaryl, halogen, cyano, nitro, —OR₆, —COR₆, —COOR₆, —OCOR₆, —CONR₆R₇, —OCONR₆R₇, —NR₆R₇, —NR₆COR₇, —NR₆COOR₇, —NR₆SO₂R₇, —SO₂NR₆R₇, and —N═N—R₆, or R₂ and R₃ together form a substituted or unsubstituted condensed benzene ring; R₄ and R₅ are each independently selected from the group consisting of hydrogen, alkyl, aryl, hetaryl, halogen, cyano, nitro, —OR₆, —COR₆, —COOR₆, —OCOR₆, —CONR₆R₇, —OCONR₆R₇, —NR₆R₇, —NR₆COR₇, —NR₆COOR₇, —NR₆SO₂R₇, —SO₂R₆, —SO₂NR₆R₇, and —N═N—R₆; and R₆ and R₇ are each independently selected from the group consisting of hydrogen, C₁-C₄alkyl, phenyl, and 4-tolyl, said method comprising:
providing as a precursor a 1,7-diarylperylene-3,4:9,10-bis(dicarboximide) having general formula B, 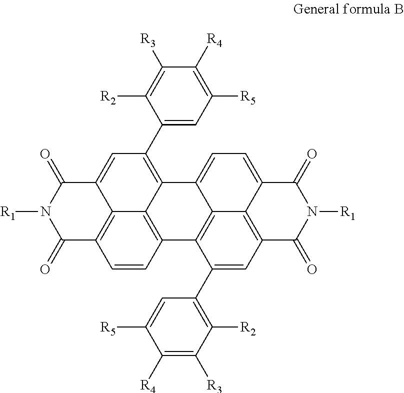
wherein R₁ to R₅ are the same as those in general formula A, and the phenyl having R₂ to R₅ or a naphthyl wherein R₂ and R₃ together form a benzene ring fused to the phenyl is photoreactive;
irradiating the precursor with light having an excitation wavelength of about 300 nm to about 450 nm until the core-expanded perylene diimide compound is synthesized.

9. The method according to claim 8, wherein each phenyl in general formula B is an unsubstituted phenyl or substituted phenyl having R₂ to R₅ wherein at least one of R₂ to R₅ is hetaryl, halogen, cyano, nitro, —COR₆, —COOR₆, or —SO₂R₆.

10. The method according to claim 8, wherein each phenyl in general formula B forms a substituted or unsubstituted naphthyl wherein R₂ and R₃ together form a benzene ring fused to the phenyl.

11. A method for synthesizing a core-expanded perylene diimide compound having general formula A: 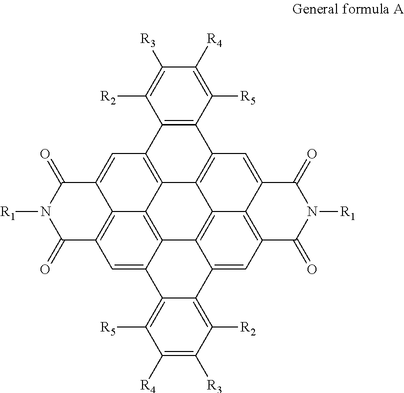
wherein R₁ is selected form the group consisting of hydrogen, alkyl, cycloalkyl, aryl, and aralkyl; R₂ and R₃ are each independently selected from the group consisting of hydrogen, alkyl, aryl, hetaryl, halogen, cyano, nitro, —OR₆, —COR₆, —COOR₆, —OCOR₆, —CONR₆R₇, —OCONR₆R₇, —NR₆R₇, —NR₆COR₇, —NR₆COOR₇, —NR₆SO₂R₇, —SO₂R₆, —SO₂NR₆R₇, and —N═N—R₆, or R₂ and R₃ together form a substituted or unsubstituted condensed benzene ring; R₄ and R₅ are each independently selected from the group consisting of hydrogen, alkyl, aryl, hetaryl, halogen, cyano, nitro, —OR₆, —COR₆, —COOR₆, —OCOR₆, —CONR₆R₇, —OCONR₆R₇, —NR₆R₇, —NR₆COR₇, —NR₆COOR₇, —NR₆SO₂R₇, —SO₂R₆, —SO₂NR₆R₇, and —N═N—R₆; and R₆ and R₇ are each independently selected from the group consisting of hydrogen, C₁-C₄alkyl, phenyl, and 4-tolyl, said method comprising:
providing as a precursor a 1,7-diarylperylene-3,4:9,10-bis(dicarboximide) having general formula B, 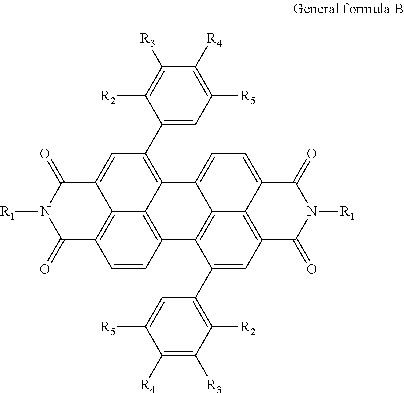
wherein R₁ to R₅ are the same as those in general formula A, and the phenyl having R₂ to R₅ or a naphthyl wherein R₂ and R₃ together form a benzene ring fused to the phenyl is electronically oxidizable; and
reacting the precursor with a Fe(III) reagent until the core-expanded perylene diimide compound is synthesized.

12. The method according to claim 11, wherein each phenyl in general formula B is a substituted phenyl having R₂ to R₅ wherein at least one of R₂ to R₅ is —OR₆ or —NR₆R₇.

13. The method according to claim 11, wherein each phenyl in general formula B forms a substituted or unsubstituted naphthyl wherein R₂ and R₃ together form a benzene ring fused to the phenyl.

14. The method according to claim 11, wherein the Fe(III) reagent is one or more selected from the group consisting of FeCl₃, FeBr₃, Fe(ClO₄)₃ and Fe(acetylacetonate)_{3.}
